(19) United States
(12) Patent Application Publication
(10) Pub. No.: US 2020/0302313 A1
(43) Pub. Date: Sep. 24, 2020

(54) ARTIFICIAL INTELLIGENCE DEVICE

(71) Applicant: LG ELECTRONICS INC., Seoul (KR)

(72) Inventor: Gyuhyeok JEONG, Seoul (KR)

(73) Assignee: LG ELECTRONICS INC., Seoul (KR)

(21) Appl. No.: 16/759,311

(22) PCT Filed: Mar. 29, 2018
(86) PCT No.: PCT/KR2018/003683

§ 371 Date: Apr. 24, 2020

(30) Foreign Application Priority Data
Oct. 27, 2017 (KR) 10-2017-0141340

(51) Int. Cl. G06N 5/04; G06N 20/00; G10L 15/22; G10L 15/08

(52) U.S. Cl. CPC G06N 5/04; G06N 20/00; G10L 2015/088; G10L 15/08; G10L 15/22

(57) ABSTRACT

Disclosed is an artificial intelligence device. The artificial intelligence device according to an embodiment of the present invention comprises a communication unit for communicating with a plurality of devices; a microphone unit for receiving voice; an artificial intelligence unit for acquiring a command phrase, and determining, on the basis of the user who uttered the command phrase and of one or more types of functions corresponding to the command phrase, a device for performing a function corresponding to the command phrase, from among the plurality of devices; and a control unit for transmitting, to the determined device, a command for performing the function corresponding to the command phrase.

### TECHNICAL FIELD

The present disclosure relates to an artificial intelligence device connected to a plurality of terminals to determine a terminal to perform a function corresponding to a command word in an environment in which the function corresponding to the command word is provided to a user.

### BACKGROUND ART

Artificial intelligence is a field of computer engineering and information technology involving studying how computers can think, learn and self-develop in ways similar to human intelligence, and means that computers can emulate intelligent actions of humans.

In addition, artificial intelligence does not exist by itself but is directly or indirectly associated with the other fields of computer science. In particular, many attempts have been made to introduce elements of artificial intelligence into various fields of information technology.

Meanwhile, in the related art, context awareness technology for recognizing a user's situation using artificial intelligence and providing desired information of a user in a desired form has actively been studied.

With development of the context awareness technology, there is an increasing need for a terminal capable of performing a function appropriate to the user's situation.

Meanwhile, electronic devices for providing various operations and functions to users through speech recognition by combining user's speech recognition and context awareness technology are increasing. Such electronic devices may be referred to as artificial intelligence devices.

In addition, the artificial intelligence device may use other peripheral devices as an output unit of various operations and functions. For example, the artificial intelligence device disposed in the home may output music through a Bluetooth speaker or output a search result through other devices.

In this case, user convenience may be enhanced depending on through which device a function corresponding to a command word of a user is output.

### INVENTION

### Technical Problem

An object of the present disclosure devised to solve the problem lies in an artificial intelligence device connected to a plurality of terminals to determine a terminal to perform a function corresponding to a command word in an environment in which the function corresponding to the command word is provided to a user.

### Technical Solution

An artificial intelligence device according to an embodiment of the present disclosure includes a communication interface configured to communicate with a plurality of devices, a microphone configured to receive voice, an artificial intelligence interface configured to acquire a command word and determine a device for performing a function corresponding to the command word among the plurality of devices based on at least one of a user who has uttered the command word or a type of the function corresponding to the command word, and a controller configured to transmit a command for performing the function corresponding to the command word to the determined device.

### Effect of the Invention

According to the present disclosure, it is possible to provide direct feedback to a user who wants to receive a function, by distinguishing a speaker who has uttered a command word and outputting a function corresponding to a command word to a personal device of the speaker who has uttered the command word.

### DESCRIPTION OF DRAWINGS

FIG. 1a is a block diagram illustrating a mobile terminal according to the present disclosure.

FIGS. 1b and 1c are conceptual views showing examples of a mobile terminal according to the present disclosure when viewed from different directions.

FIG. 2 is a conceptual view of a deformable mobile terminal according to another embodiment of the present disclosure.

FIG. 3 is a perspective view illustrating one example of a watch-type mobile terminal in accordance with another embodiment of the present disclosure.

FIG. 4 is a perspective view illustrating one example of a glass-type mobile terminal according to another embodiment of the present disclosure.

FIG. 5 is a flowchart illustrating a method of operating a mobile terminal according to an embodiment of the present disclosure.

FIG. 6 is a view showing an artificial intelligence device for communicating with a plurality of devices and receiving command words from a plurality of users, according to an embodiment of the present disclosure.

FIGS. 7 and 8 are views illustrating a method of determining a device for performing a function corresponding to a command word based on a user who has uttered the command word, according to an embodiment of the present disclosure.

FIGS. 9 and 10 are views illustrating a method of determining a device for performing a function corresponding to a command word based on a user who has uttered the command word, according to another embodiment of the present disclosure.

FIGS. 11 to 12 are views illustrating a method of determining a device to perform a function corresponding to a command word based on the type of the function corresponding to the command word, according to an embodiment of the present disclosure.

FIGS. 13 to 14 are views illustrating a method of determining a device to perform a function corresponding to a command word based on the type of the function corresponding to the command word and a user who has uttered the command word, according to an embodiment of the present disclosure.

FIG. 15 is a view illustrating a method of performing a function corresponding to preferred information using preferred information of a user who has uttered a command word, according to an embodiment of the present disclosure.

FIG. 16 is a view illustrating a method of acquiring a command word through an external device and performing a function corresponding thereto, according to another embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

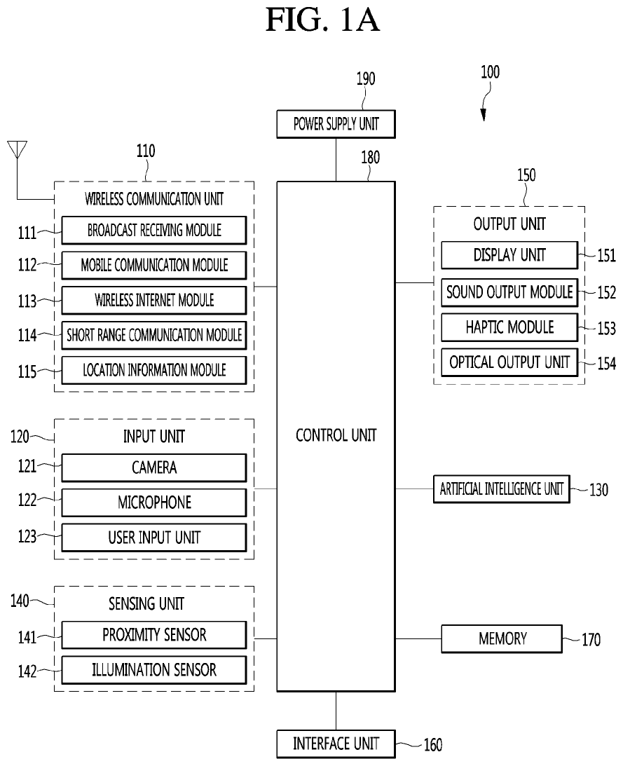

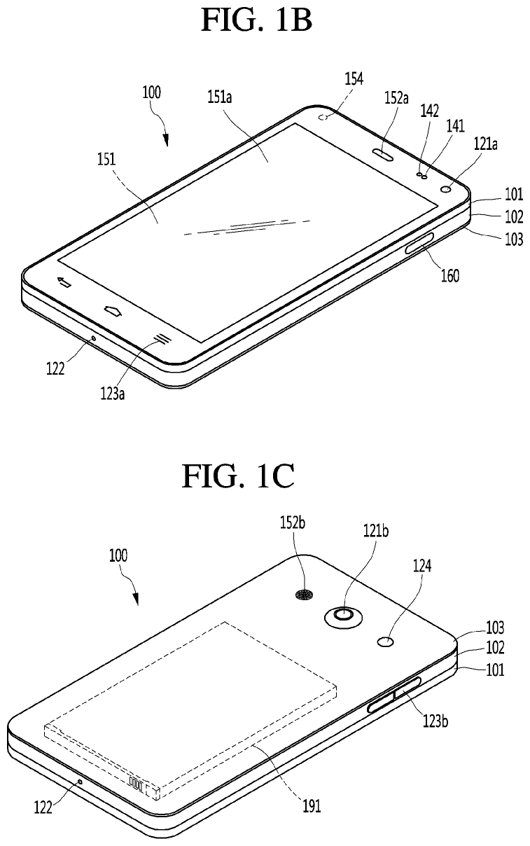

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

An artificial intelligence unit 130 is responsible for processing information based on artificial intelligence technology and may include one or more modules for performing at least one of learning of information, inference of information, perception of information and processing of a natural language.

The artificial intelligence unit 130 may perform at least one of learning, inference and processing of vast amounts of information (big data) such as information stored in the mobile terminal, surrounding environmental information of the mobile terminal and information stored in a communicable external storage. In addition, the artificial intelligence unit 130 may control the mobile terminal to predict (infer) executable operation of at least one mobile terminal and to perform most feasible operation of the at least one predicted operation, using the information learned using the machine learning technology.

The machine learning technology refers to technology of collecting and learning a large amount of information based on at least one algorithm and determining and predicting information based on the learned information. Learning of information refers to operation for grasping the characteristics, rules and criteria of judgement of the information, quantifying a relationship between information and information, and predicting new data using a quantified pattern.

An algorithm used by such machine learning technology may be a statistical based algorithm and may include, for example, a decision tree using a tree structure as a prediction model, an artificial neural network for emulating the neural network structure and function of an organism, genetic programing based on biological evolutionary algorithms, clustering for distributing observed examples into subsets such clusters, and a Monte-Carlo method of calculating the probability of a function value through a randomly extracted number.

As a field of machine learning technology, deep learning technology refers to technology of performing at least one of learning, determining and processing of information using an artificial neural network algorithm. The artificial neural network may have a structure for connecting a layer and a layer and transmitting data between the layer and the layer. Such deep learning technology may learn vast amounts of information through an artificial neural network using a graphic processing unit (GPU) optimized for parallel computation.

Meanwhile, the artificial intelligence unit 130 may collect (sense, monitor, extract, detect or receive) signals, data, information, etc. input to or output from the components of the mobile terminal in order to collect vast amounts of information for applying machine learning technology. In addition, the artificial intelligence unit 130 may collect (sense, monitor, extract, detect or receive) data, information, etc. stored in an external storage (e.g., a cloud server) connected through communication. More specifically, collection of information may be understood as the term including sensing of information through a sensor, extraction of information stored in the memory 170, or reception of information from the external storage through communication.

The artificial intelligence unit 130 may sense information in the mobile terminal, surrounding environment information of the mobile terminal and user information through the sensing unit 140. In addition, the artificial intelligence unit 130 may receive a broadcast signal and/or broadcast related information, wireless signal, wireless data, etc. through the wireless communication unit 110. In addition, the artificial intelligence unit 130 may receive image information (or signal), audio information (or signal), data or information input by a user from the input unit.

Such an artificial intelligence unit 130 may collect vast amounts of information in real time in the background and learn the information, and store information processed in an appropriate form (e.g. knowledge graph, command policy, personalization database, dialog engine, etc.) in the memory 170.

In addition, when operation of the mobile terminal is predicted based on the information learned using the machine learning technology, the artificial intelligence unit 130 may control the components of the mobile terminal and send a control command for executing the predicted operation to the controller 180, in order to execute the predicted operation. The controller 180 may control the mobile terminal based on the control command to execute the predicted operation.

Meanwhile, when specific operation is performed, the artificial intelligence unit 130 may analyze history information indicating performing of the specific operation through machine learning technology and update existing learned information based on the analyzed information. Therefore, the artificial intelligence unit 130 may improve information prediction accuracy.

Meanwhile, in this specification, the artificial intelligence unit 130 and the controller 180 may be understood as the same component. In this case, the function performed by the controller 180 described in this specification may be described as being performed by the artificial intelligence unit 130, and the controller 180 may be referred to as the artificial intelligence unit 130 or the artificial intelligence unit 130 may be referred to as the controller 180.

Alternatively, in this specification, the artificial intelligence unit 130 and the controller 180 may be understood as different components. In this case, the artificial intelligence unit 130 and the controller 180 may perform a variety of control on the mobile terminal through data exchange. The controller 180 may perform at least one function on the mobile terminal based on a result derived from the artificial intelligence unit 130 or control at least one of the components of the mobile terminal. Further, the artificial intelligence unit 130 may operate under control of the controller 180.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the above-described components, or activating application programs stored in the memory 170.

In addition, the controller 180 controls at least some of the components illustrated in FIG. 1A, in order to execute the application program stored in the memory 170. Further, the controller 180 may operate a combination of at least two of the components included in the mobile terminal 100, in order to execute the application program.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Hereinafter, prior to description of various embodiments implemented via the above-described mobile terminal 100, the above-described components will be described in greater detail with reference to FIG. 1A.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be a server which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sensing unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood as referring to the mobile terminal 100 as at least one assembly.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal includes a display unit 151, a first and a second audio output modules 151a/151b, a proximity sensor 141, an illumination sensor 142, an optical output module 154, a first and a second cameras 121a/121b, a first and a second manipulation units 123a/123b, a microphone 122, interface unit 160 and the like.

It will be described for the mobile terminal as shown in FIGS. 1B and 1C. The display unit 151, the first audio output module 151a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 151b and the second camera 121b are arranged in rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 displays (outputs) information processed in the mobile terminal 100. The display 151 may execution screen information of an application program executed on the mobile terminal 100 or user interface (UI) or graphical user interface (GUI) information according to such execution screen information.

The display unit 151 include at least one of a liquid crystal display (LCD), a thin film transistor-liquid crystal display (TFT-LCD), an organic light emitting diode (OLED), a flexible display, a 3-dimensional (3D) display, or an e-ink display.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

In the present disclosure, information processed in a mobile terminal may be displayed using a flexible display. Hereinafter, this will be described in greater detail with reference to the accompanying drawings.

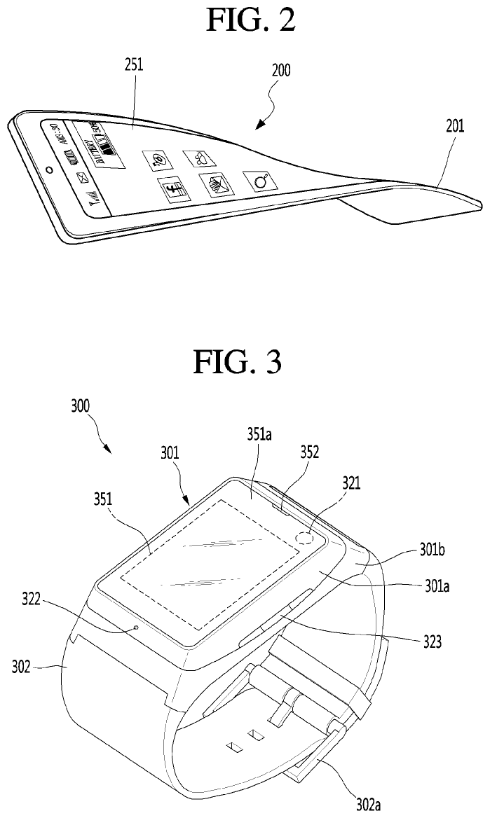

FIG. 2 is a conceptual view of a deformable mobile terminal according to an alternative embodiment of the present disclosure.

In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

FIG. 3 is a perspective view illustrating one example of a watch-type mobile terminal 300 in accordance with another exemplary embodiment.

As illustrated in FIG. 3, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

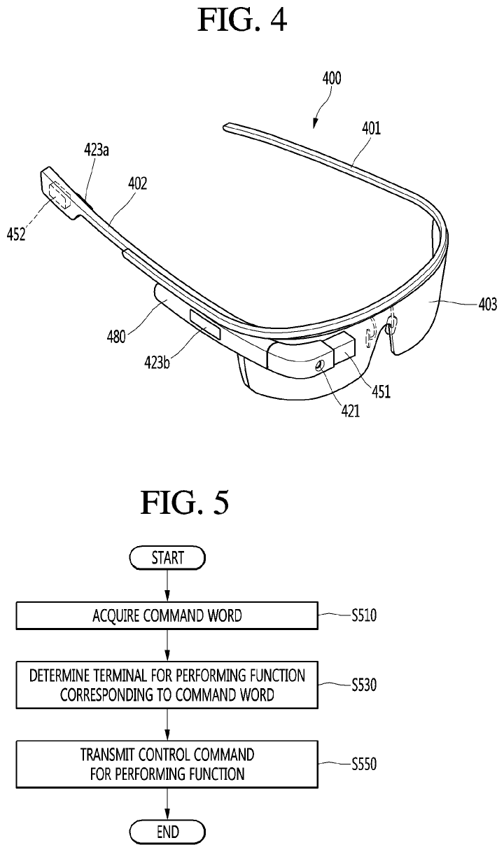

FIG. 4 is a perspective view illustrating one example of a glass-type mobile terminal 400 according to another exemplary embodiment.

The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In general, mobile terminal 400 may be configured to include features that are the same or similar to that of mobile terminal 100 of FIGS. 1A-1C.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display.

The camera 421 may be located adjacent to either or both of the left and right eyes to capture an image. Since the camera 421 is located adjacent to the eye, the camera 421 can acquire a scene that the user is currently viewing.

Although the camera 421 is shown as being provided in the control module 480 in this figure, the present disclosure is not limited thereto. The camera 421 may be positioned at most any location of the frame. In some embodiments, multiple cameras 421 may be utilized. Such multiple cameras 421 may be used to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

If desired, mobile terminal 400 may include a microphone which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

Next, a communication system which is operable with the variously described mobile terminals will now be described in more detail.

Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system.

A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server.

The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal.

Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™, Radio Frequency Identification (RFID), Infrared Data Association (IrDA), UltraWideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, if a mobile terminal having card information on a payment card (e.g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the form of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In this case, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NFC communication is relatively short.

Further preferred embodiments will be described in more detail with reference to additional drawing figures. It is understood by those skilled in the art that the present features can be embodied in several forms without departing from the characteristics thereof.

In this specification, the term memory 170 may be used interchangeably with the term storage 170.

The controller 180 may control operation of each component of the mobile terminal 100 under control of the artificial intelligence unit 130.

The input unit 120 of the mobile terminal 100 may include the sensing unit 140 and perform all functions performed by the sensing unit 140. For example, the input unit 120 may detect user touch input.

The wireless communication unit 110 may be used interchangeably with the term communication unit 110. In addition, the communication unit 110 may include the interface unit 160 and perform all functions performed by the interface unit 160.

The term microphone 122 may be used interchangeably with the term mic 122.

In FIGS. 1 to 4, a mobile terminal has been described as an artificial intelligence device according to an embodiment of the present disclosure.

The present disclosure is not limited thereto and the present disclosure is applicable to all artificial intelligence devices each having an artificial intelligence function.

Hereinafter, the artificial intelligence device according to the embodiment of the present disclosure will be described using the components of the mobile terminal. The artificial intelligence device may include some or all of the components of the mobile terminal described with reference to FIGS. 1 to 4.

FIG. 5 is a flowchart illustrating a method of operating an artificial intelligence device according to an embodiment of the present disclosure.

The method of operating the artificial intelligence device according to the embodiment of the present disclosure includes acquiring a command word (S510), determining a terminal for performing a function corresponding to the command word among a plurality of terminals based on at least one of the type of the function corresponding to the command word or a user who has uttered the command word (S530), and transmitting a control command for performing the function corresponding to the command word to the determined terminal (S550).

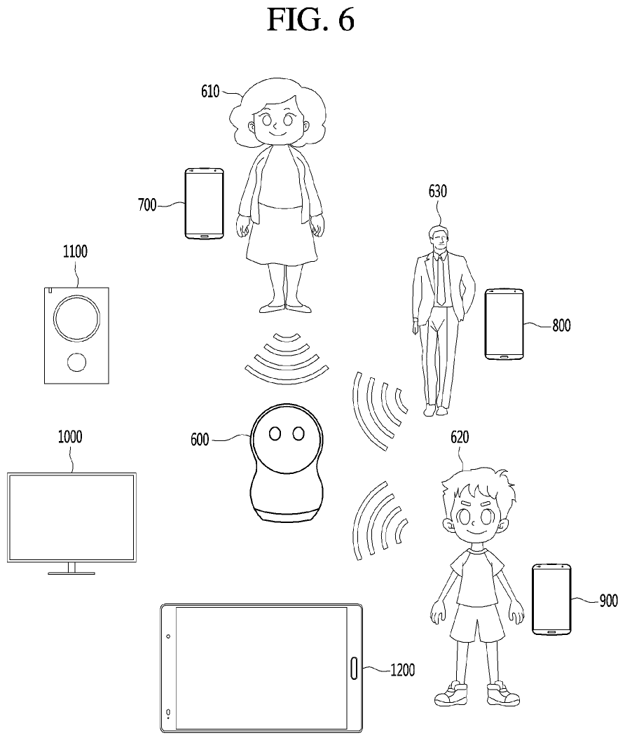

FIG. 6 is a view showing an artificial intelligence device for communicating with a plurality of devices and receiving command words from a plurality of users, according to an embodiment of the present disclosure.

The controller 180 of the artificial intelligence device 600 may communicate with a plurality of devices 700, 800, 900, 1000, 1100 and 1200 via the communication unit 110.

Here, the plurality of devices 700, 800, 900, 1000, 1100 and 1200 may be electronic devices located together at a specific place.

For example, the plurality of devices 700, 800, 900, 1000, 1100 and 1200 may include a first personal device 00, a second personal device 800, a third personal device 900, a first shared device 1000, a second shared device 1100, and a third shared device 1200, all of which are located in the home.

Here, the first personal device 700 may be registered as the personal device of a first user 610, the second personal device 800 may be registered as the personal device of a second user 630, and the third personal device 300 may be registered as the personal device of a third user 620.

Each of the personal devices 700, 800 and 900 may be the mobile terminal described with reference to FIGS. 1 to 4.

In addition, the shared devices 1000, 1100 and 1200 may be registered to be shared and used by two or more of the plurality of users 610, 620 and 630.

As the example of the shared device, the first shared device 1000 may be a display device such as a TV, the second shared device 1100 may be a Bluetooth speaker, and the third public device 1200 may be a tablet PC.

The plurality of devices 700, 800, 900, 1000, 1100 and 1200 may output at least one of video or audio.

The artificial intelligence unit 130 of the artificial intelligence device 600 may acquire the command word. Specifically, the mic 122 may receive user voice, and the controller 180 may acquire a command word included in the received voice.

In addition, the artificial intelligence unit 130 of the artificial intelligence device 600 may perform a function corresponding to the acquired command word.

For example, when the acquired command word is “Please output a today's schedule”, the artificial intelligence unit 130 of the artificial intelligence device 600 may search for the today's schedule and output the result of search.

In this case, the artificial intelligence unit 130 of the artificial intelligence device 600 may perform the function corresponding to the command word using the output unit included in the artificial intelligence device 600.

For example, the artificial intelligence unit 130 of the artificial intelligence device 600 may control the display unit 151 of the artificial intelligence device 600 to display text or an image indicating the today's schedule.

In another example, the artificial intelligence unit 130 of the artificial intelligence device 600 may control the audio output unit 152 of the artificial intelligence device 600 to output sound indicating the today's schedule.

The artificial intelligence unit 130 of the artificial intelligence device 600 may transmit a command for performing the function corresponding to the command word to any one of the plurality of devices 700, 800, 900, 1000, 1100 and 1200, such that the function corresponding to the command word is performed in any one of the plurality of devices 700, 800, 900, 1000, 1100 and 1200.

For example, when the acquired command word is “Please play music”, the artificial intelligence unit 130 of the artificial intelligence device 600 may transmit a command for outputting music to the second personal device 800.

The command for performing the function corresponding to the command word may include a control command for outputting content and content to be output.

For example, when the acquired command word is “Please search for todays' schedule”, the artificial intelligence unit 130 of the artificial intelligence device 600 may transmit a control command for outputting the today's schedule and text indicating the today's schedule to the second personal device 800. In addition, the controller of the second personal device 800, which has received the command, may control the display unit of the second personal device 800 to display the received text.

However, the present disclosure is not limited thereto and the command for performing the function corresponding to the command word may include a control command for outputting content.

For example, when the acquired command word is “Please play music”, the artificial intelligence unit 130 of the artificial intelligence device 600 may transmit a control command for outputting music to the second personal device 800. The controller of the second personal device 800, which has received the command, may output music using the content (music) stored in the storage of the second personal device 800.

The storage 170 of the artificial intelligence device 600 may store a plurality of pieces of voice information respectively corresponding to the plurality of users.

For example, the storage 170 of the artificial intelligence device 600 may store the voice information of the first user 610, the voice information of the second user 630 and the voice information of the third user 620.

Here, the voice information may include vocal information of the user for distinguishing a speaker.

In addition, the storage 170 of the artificial intelligence device 600 may store a plurality of pieces of device information respectively corresponding to the plurality of users.

For example, the storage 170 of the artificial intelligence device 600 may store information on the first personal device 700 which is the personal device of the first user 610, information on the second personal device 800 which is the personal device of the second user, and information on the third personal device 900 which is the personal device of the third user 620.

In addition, the storage 170 of the artificial intelligence device 600 may store voice information respectively corresponding to the plurality of personal devices.

Specifically, the storage 170 of the artificial intelligence device 600 may store the voice information of the first user 610 who is the user of the first personal device 700, the voice information of the second user 630 who is the user of the second personal device 800, and the voice information of the third user 620 who is the user of the third personal device 900.

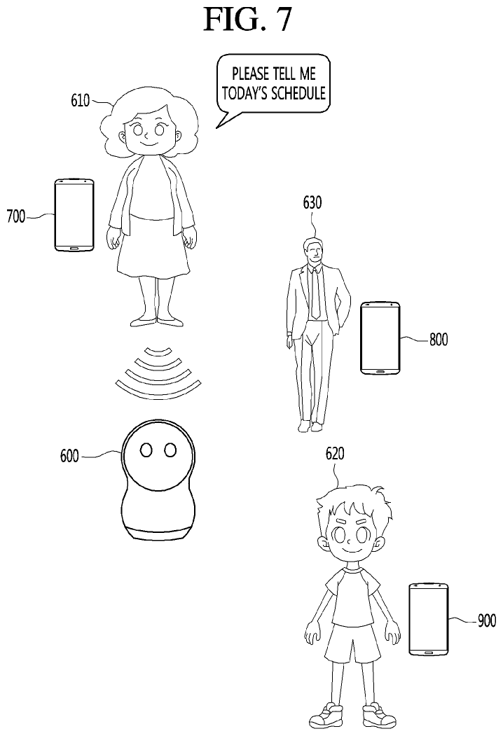

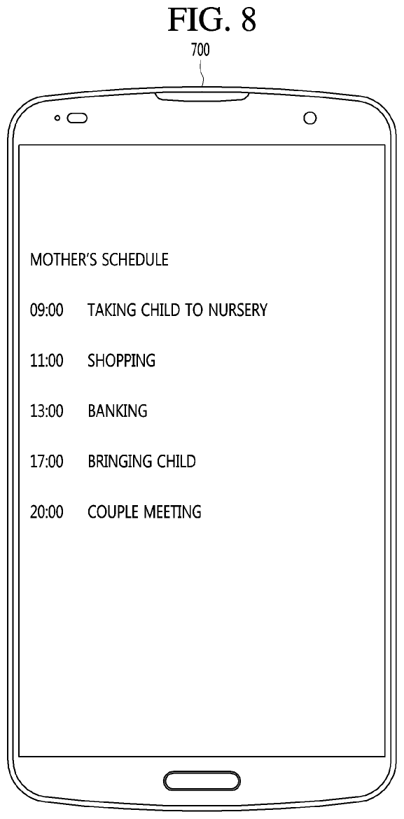

FIGS. 7 and 8 are views illustrating a method of determining a device for performing a function corresponding to a command word based on a user who has uttered the command, according to an embodiment of the present disclosure.

The artificial intelligence unit 130 of the artificial intelligence device 600 may determine who has uttered the command word.

Specifically, the artificial intelligence unit 130 may determine who has uttered the command word using the vocal information of a plurality of users 610, 620 and 630 and the voice received through the mic 122.

For example, the storage 170 may store the vocal information of a mother, a father and a son. In addition, when the mother utters a command word “Please tell me today's schedule”, the artificial intelligence unit 130 may determine that the user who has uttered the command word is the mother using the vocal information of the mother, the father and the son and the voice received through the mic 122.

The artificial intelligence unit 130 may determine a device for performing the function corresponding to the command word among a plurality of devices 700, 800 and 900 based on the user who has uttered the command word.

Specifically, the artificial intelligence unit 130 may determine the device of the user who has uttered the command word as the device for performing the function corresponding to the command word, based on a plurality of pieces of device information respectively corresponding to the plurality of users.

For example, when the motor who is the first user 610 utters the command word “Please tell me today's schedule”, the artificial intelligence unit 130 may output the today's schedule of the motor who is the first user 610. In this case, the artificial intelligence unit 130 may determine the first personal device 700 of the first user 610 among the plurality of devices 700, 800 and 900 as the device for performing the function corresponding to the command word, because the command word is uttered by the first user 610.

The function corresponding to the command word may be to display an answer to information requested by the user. In this case, the first personal device 700 may display the today's schedule of the mother, as shown in FIG. 8.

In addition, the function corresponding to the command word may be to output the answer to the information requested by the user as an audio signal. In this case, the first personal device 700 may output the today's schedule of the mother as the audio signal.

The controller 180 may transmit the command for performing the function corresponding to the command word to the determined device, under control of the artificial intelligence unit 130.

For example, the controller 180 may transmit a command for outputting the information requested by the user to the first personal device 700 of the first user 610.

In this specification, “determining of the device for performing the function corresponding to the command word”, “transmitting of the command for performing the function corresponding to the command word” may mean that the function corresponding to the command word is output.

Specifically, performing of the function corresponding to the command word may include determination of the function to be provided to the user according to the command word and output of the determined function.

In addition, when the command word is received from the user, determination of the function to be provided to the user according to the received command word may be performed in the artificial intelligence device 600.

In addition, the artificial intelligence unit 130 of the artificial intelligence device 600 may determine a device which will output the determined function, and transmit the command for outputting the function corresponding to the command word to the determined device.

For example, when a command word “Please search for shopping information” is received from the first user 610, the artificial intelligence device 600 may determine that the shopping information is searched for and displayed according to the received command. In addition, the artificial intelligence unit 130 of the artificial intelligence device 600 may determine the device for outputting the shopping information as the first personal device 700. In addition, the controller 180 of the artificial intelligence device 600 may transmit the command for displaying the shopping information to the first personal device 700. In this case, the command for outputting the shopping information may include the searched content (shopping information). When the command for outputting the shopping information is received, the first personal device 700 may display the searched content (shopping information).

Although the artificial intelligence device may provide feedback to the user's request, such a feedback method may be restricted by the performance and location of the artificial intelligence device.

For example, in the case of pathfinding, shopping, video education, etc., although the visual output of feedback is more suitable for the user's purpose, the artificial intelligence device may have only an audio output unit without a display unit, or the performance of the display unit of the artificial intelligence device may deteriorate.

As another example, since the artificial intelligence device may be located in a living room but the user is located in a main room, the user needs to move to the living room in order to receive the feedback.

However, in the present disclosure, it is possible to provide information to the user using an optimal method, by outputting the function corresponding to the command word through a device other than the artificial intelligence device.

In addition, the present disclosure has the advantage of providing direct feedback to a user who wants to receive a function, by distinguishing a speaker who has uttered a command word and transmitting the function corresponding to the command word to the personal device of the speaker who has uttered the command word.

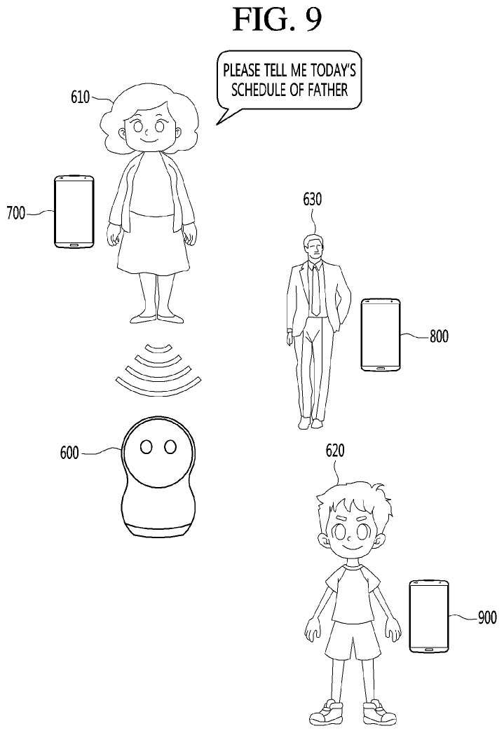

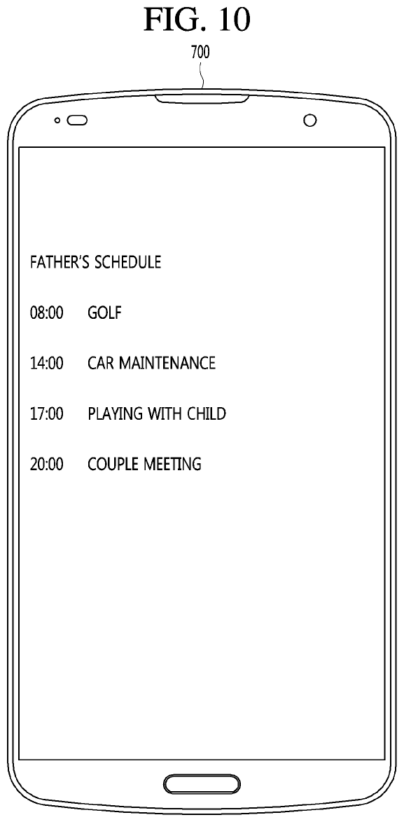

FIGS. 9 and 10 are views illustrating a method of determining a device for performing a function corresponding to a command word based on a user who has uttered the command word, according to another embodiment of the present disclosure.

The artificial intelligence unit 130 of the artificial intelligence device 600 may determine who has uttered the command word.

For example, the storage 170 may store the vocal information of the mother, the father and the son. In addition, when the mother utters a command word “Please tell me the today's schedule of the father”, the artificial intelligence unit 130 may determine that the user who has uttered the command word is the mother using the vocal information of the mother, the father and the son and the voice received through the mic 122.

The artificial intelligence unit 130 may determine the function to be provided to the user according to the received command word.

For example, when the command word “Please tell me the today's schedule of the father” is received from the mother who is the first user 610, the artificial intelligence unit 130 may determine that the schedule of the father is searched for and displayed according to the received command word.

In addition, the artificial intelligence unit 130 may determine a device for outputting the function corresponding to the command word among the plurality of devices 700, 800 and 900 based on the user who has uttered the command word.

For example, when the command word “Please tell me the today's schedule of the father” is uttered by the first user 610 (mother), the artificial intelligence unit 130 may determine the first personal device 700 of the first user 610 among the plurality of devices 700, 800 and 900 as the device for outputting the function corresponding to the command word.

In this case, the controller 180 may transmit the command for outputting the function corresponding to the command word to the determined device, under control of the artificial intelligence unit 130. Here, the command for outputting the function corresponding to the command word may include content to be output.

For example, the controller 180 may transmit the command for outputting the today's schedule of the father to the first personal device 700 of the first user 610. Here, the command for outputting the today's schedule of the father may include the today's schedule of the father.

In addition, when input of outputting the function corresponding to the command word is received, as shown in FIG. 10, the controller of the first personal device 700 may output (display) the function corresponding to the command word, that is, the today's schedule of the father.

There may be various methods of outputting the feedback to the user's request through the device other than the artificial intelligence device.

For example, the feedback to the user's request may be output through the personal device of the user (if the command word is “Please tell me today's schedule of the father”, the father) corresponding to the command word, and may be output through a device which is preset to output the feedback.

In this case, the information may not be directly transmitted to the user who requires the feedback.

However, in the present disclosure, it is possible to provide direct feedback to the user who wants to receive the function, by distinguishing between a user (if the command word is “Please tell me today's schedule of the father”, the father) corresponding to the command word and the user who has uttered the command word and outputting the function corresponding to the command word through the personal device of the user who has uttered the command word.

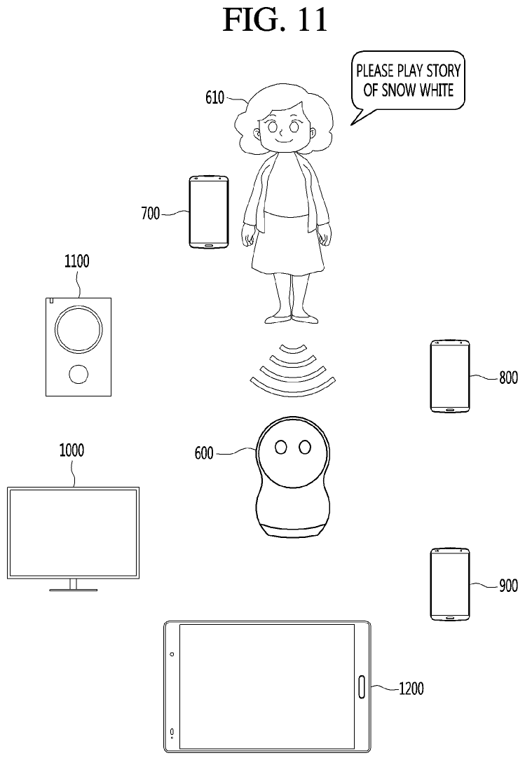

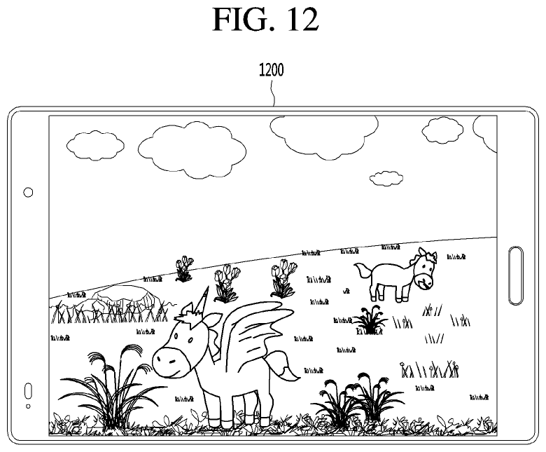

FIGS. 11 to 12 are views illustrating a method of determining a device to perform a function corresponding to a command word based on the type of the function corresponding to the command word, according to an embodiment of the present disclosure.

The function corresponding to the command word may include various types of functions.

For example, the function corresponding to the command word may include a first type of function, a second type of function, a third type of function and a fourth type of function. Here, the first type of function may be a function related to children's content, the second type of function may be a function related to pathfinding, the third type of function may be a function related to shopping, and the fourth type of function may be a function related to music.

The storage 170 may store types of functions corresponding to the plurality of devices 700, 800, 900, 1000, 1100 and 1200.

For example, the storage 170 may store information indicating that the function corresponding to a tablet PC 1200 is the first type of function and the function corresponding to a Bluetooth speaker 1100 is the fourth type of function.

As another example, the storage 170 may store information indicating that the function of a display installed in a refrigerator is the third type of function and the function corresponding to a navigation system is the second type of information.

The artificial intelligence unit 130 may determine a device for performing the function corresponding to the command word among the plurality of devices, based on the type of the function corresponding to the command word.

Specifically, the artificial intelligence unit 130 may determine the type of the function corresponding to the command word.

For example, when the command word is “Please play the story of Snow White”, the artificial intelligence unit 130 may determine that the function corresponding to the command word is output of the story of Snow White and may determine the first type of function which is the function related to children's content.

In this case, the artificial intelligence unit 130 may determine the device for performing the function corresponding to the command word, based on the type of the function corresponding to the command word and the types of functions corresponding to the plurality of devices.

For example, when the function corresponding to the command word is the first type of function, the artificial intelligence unit 130 may determine the tablet PC for performing the first type of function among the plurality of devices as the device for performing the function corresponding to the command word.

In this case, the controller 180 may transmit the command for performing the function corresponding to the command word to the determined device, under control of the artificial intelligence unit 130.

For example, the controller 180 may transmit the command for outputting the story of Snow White to the tablet PC.

When the command for performing the function corresponding to the command word is received, as shown in FIG. 12, the tablet PC 1200 may output the function corresponding to the command word. For example, the tablet PC 1200 may play the story of Snow White.

Although content (e.g., the video of the story of Snow White) has been described as being transmitted to the device (e.g., the tablet PC) determined to perform the function in the artificial intelligence device, the present disclosure is not limited thereto. Specifically, the content may be pre-stored in the device (e.g., the tablet PC) determined to perform the function and, in this case, the device determined to perform the function may play back the stored content.

The type of the function corresponding to the received command word may correspond to the plurality of devices.

For example, the received command may be “Please play the story of Snow White”, the function corresponding to the command word may be the first type of function which is the function related to children's content, and the device for performing the first type of function includes the tablet PC 1200 and a TV 1000.

In this case, the artificial intelligence unit 130 may determine, as the device for performing the function corresponding to the command word, a preferred device of the user who has uttered the command word among the plurality of devices for performing the function corresponding to the command word.

Specifically, the artificial intelligence unit 130 may store information on the preferred devices of the plurality of users in the storage 170.

Here, the preferred device may be registered by the user.

In addition, the preferred device may be acquired based on the past device usage history of the user.

For example, when the function corresponding to the command word is the first type of function and a first user mainly outputs the first type of function through the tablet PC 1200, the artificial intelligence unit 130 may determine, as the device for performing the function corresponding to the command word, the tablet PC 1200 which is the preferred device of the first user who has uttered the command word among the plurality of devices for performing the first type of function.

The device, through which the user receives the feedback, may vary according to the purpose of the user.

For example, the mother may use the tablet PC for education of her child, mainly receive shopping information through the display installed in the refrigerator located in the kitchen, and listen to music through the Bluetooth speaker.

The present disclosure has an advantage of providing the feedback through the device suiting the purpose of the user, by determining the device for performing the function corresponding to the command word according to the type of the function corresponding to the command word.

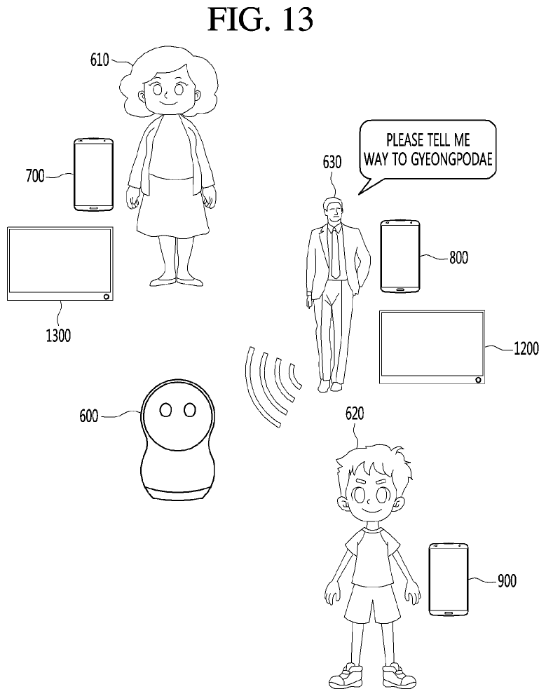

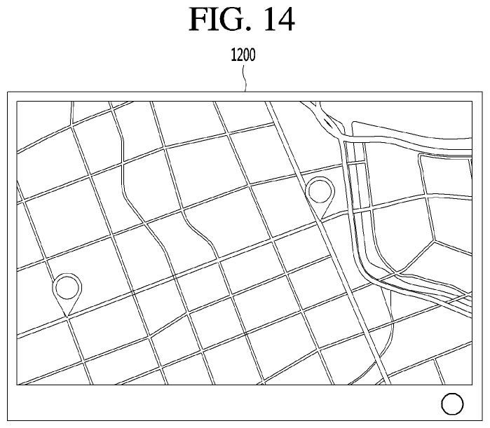

FIGS. 13 to 14 are views illustrating a method of determining a device to perform a function corresponding to a command word based on the type of the function corresponding to the command word and a user who uttered the command word, according to an embodiment of the present disclosure.

The artificial intelligence unit 130 may determine the function corresponding to the received command word. For example, when the received command is “Please tell me the way to Gyeongpodae”, the artificial intelligence unit 130 may determine that a function for guiding the way to Gyeongpodae is provided.

The artificial intelligence unit 130 may determine the device for performing the function corresponding to the command word among the plurality of devices based on the user who has uttered the command word and the type of the function corresponding to the command word.

Specifically, the artificial intelligence unit 130 may determine who is the user who has uttered the command word.

When the father who is the second user 630 has uttered the command word “Please tell me the way to Gyeongpodae”, the artificial intelligence unit 130 may determine that the user who has uttered the command word is the second user 630.

In addition, the artificial intelligence unit 130 may determine the type of the function corresponding to the command word.

For example, when the command word is “Please tell me the way to Gyeongpodae”, the artificial intelligence unit 130 may determine that the type of the function corresponding to the command word is the second type of function which is the function related to pathfinding.

In addition, the artificial intelligence unit 130 may determine the device for performing the function corresponding to the command word among the plurality of devices based on the user who has uttered the command word and the type of the function corresponding to the command word.

Specifically, when the user who has uttered the command word is the second user 630, the device corresponding to the second user 630 may be a (2-1)-th personal device 800 and a (2-2)-th personal device 1200 of the second user 630.

For example, the device corresponding to the father may include a mobile phone of the father and a navigation system mounted in the vehicle of the father.

In this case, the artificial intelligence unit 130 may determine, as the device for performing the function corresponding to the command word, the (2-2)-th personal device 1200 corresponding to the type of the function corresponding to the command word among the plurality of devices 800 and 1200 corresponding to the second user 630.

For example, when the type of the function corresponding to the command word is the second type of function related to pathfinding and the device corresponding to the second type between the mobile phone of the father and the navigation system mounted in the vehicle of the father is the navigation system, the artificial intelligence unit 130 may determine the navigation system as the device for performing the function corresponding to the command word.

In this case, the controller 180 may transmit the command for performing the function corresponding to the command word to the (2-2)-th personal device 1200, under control of the artificial intelligence unit 130.

In this case, as shown in FIG. 14, the (2-2)-th personal device may perform the function corresponding to the command word.

For example, the navigation system may guide the way to Gyeongpodae in correspondence with “Please tell me the way to Gyeongpodae”.

In this case, the navigation system may display a guide standby screen and start to guide the way when the user arrives at the vehicle.

The present disclosure has an advantage of providing the feedback to the device suiting the purpose of the user among the devices of the user who has requested the function.

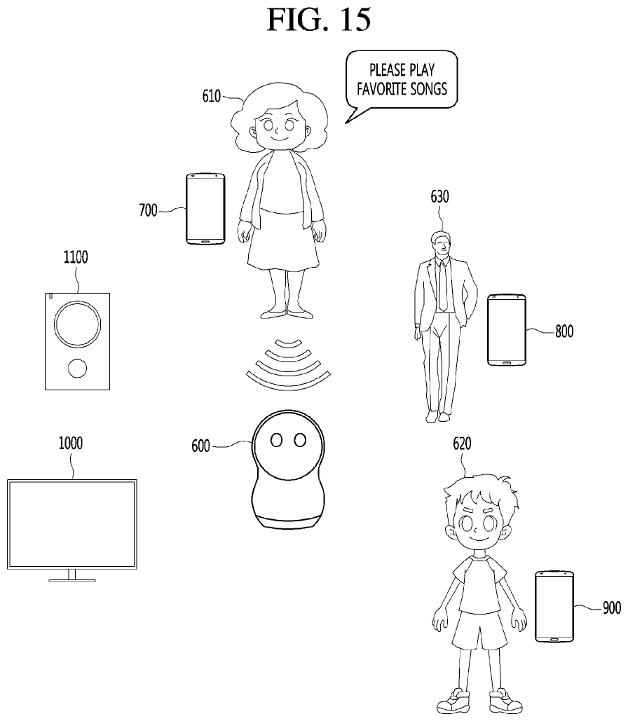

FIG. 15 is a view illustrating a method of performing a function corresponding to preferred information using preferred information of a user who has uttered a command, according to an embodiment of the present disclosure.

The artificial intelligence unit 130 of the artificial intelligence device 600 may determine who is the user who has uttered the command word.

For example, when the mother who is the first user 610 utters the command word “Please play favorite songs”, the artificial intelligence unit 130 may determine that the user who has uttered the command word is the mother who is the first user 610.

Meanwhile, the storage 170 of the artificial intelligence device 600 may store preferred information corresponding to each of the plurality of users.

For example, the storage 170 of the artificial intelligence device 600 may store information on a music genre preferred by each of the plurality of users.

In this case, based on the preferred information of the user who has uttered the command word, the artificial intelligence unit 130 may perform the function corresponding to the preferred information of the user who has uttered the command word.

For example, when the user who has uttered the command word “Please play favorite songs” is determined as the mother who is the first user 610 and the music genre preferred by the mother is a ballad, the artificial intelligence unit 130 may search for music of the ballad genre.

In addition, the artificial intelligence unit 130 may determine the device for outputting the function corresponding to the command word among the plurality of devices 700, 800, 900, 1000 and 1100, based on at least one of the user who has uttered the command word or the type of the function corresponding to the command word.

For example, when the function corresponding to the command word “Please play favorite songs” is the fourth type of function which is the music output function, the artificial intelligence unit 130 may determine the device for outputting music as the Bluetooth speaker 1100 corresponding to the fourth type of function.

In this case, the controller 180 may transmit a command for outputting music to the Bluetooth speaker 1100, under control of the artificial intelligence unit 130.

As another example, when a command word “Please search for interesting content” is received from a mother in her 30s and the preferred information of mothers in her 30s is cooking and fashion, the artificial intelligence unit 130 may search for content related to cooking and fashion. In addition, the artificial intelligence unit 130 may transmit a command for playing the content related to cooking and fashion to the mobile terminal 700 of the mother.

The present disclosure has an advantage of directly providing a service suitable for the preference of the user who wants to receive the function to the user who wants to receive the function.

The artificial intelligence unit 130 may determine the device for performing the function corresponding to the command word such that the function corresponding to the command word is performed in two or more of the plurality of devices and the artificial intelligence device.

Specifically, the function corresponding to the command word may include a first function and a second function.

For example, when the function corresponding to the command word is a music playing function, the first function may be a music output function and the second function may be a lyrics display function.

In this case, the artificial intelligence unit 130 may determine the device for performing the function corresponding to the command word, such that the function corresponding to the command word is performed in two or more of the plurality of devices and the artificial intelligence device, based on at least one of the user who has uttered the command word or the type of the function corresponding to the command word.

For example, when the function corresponding to the command word “Please play favorite songs” is the fourth type of function which is the music playing function, the artificial intelligence unit 130 may determine the device for performing the music output function as the Bluetooth speaker 1100 corresponding to the fourth type of function.

In addition, when the user who has uttered the command word “Please play favorite songs” is the mother, the artificial intelligence unit 130 may determine the device for performing the music playing function as the mobile terminal 700 of the mother who has uttered the command word.

In this case, the artificial intelligence unit 130 may transmit a command for performing the music output function which is the first function of the music playing function to the Bluetooth speaker 1100, and transmit a command for performing the lyrics display function which is the second function of the music playing function to the mobile terminal 700 of the mother.

In this case, the Bluetooth speaker 1100 may output audio and the mobile terminal 700 of the mother may display the lyrics of the music which is currently being played.

In addition, the first function may be performed in the artificial intelligence device 600 and the second function may be performed in another device.

For example, when the command word “Please search for today's schedule” is received from the mother, the first function may be a function for outputting audio indicating the today's schedule and the second function may be a function for displaying text indicating the today's schedule.

In this case, the artificial intelligence unit 130 may determine the device for performing the function corresponding to the command word, such that the function corresponding to the command word is performed in at least two of the plurality of devices and the artificial intelligence device, based on at least one of the user who has uttered the command word and the type of the function corresponding to the command word.

Specifically, the artificial intelligence unit 130 of the artificial intelligence device 600 may determine that the first function is performed in the artificial intelligence device 600. In addition, based on at least one of the user who has uttered the command word or the type of the function corresponding to the command word, the device for performing the second function may be determined as the first personal device 700.

For example, when a command “Please search for today's schedule” is received from the mother, the artificial intelligence unit 130 of the artificial intelligence device 600 may control the audio output unit 152 of the artificial intelligence device 600 to output audio indicating the today's schedule. In addition, the artificial intelligence unit 130 of the artificial intelligence device 600 may transmit a command for displaying text indicating the today's schedule to the first personal device 700.

In this case, the audio output unit 152 of the artificial intelligence device 600 may output audio indicating the today's schedule and the first personal device 700 may display text indicating the today's schedule.

The present disclosure has an advantage of providing optimal feedback to the user, by sharing the functions performed in correspondence with one command word between the plurality of devices.

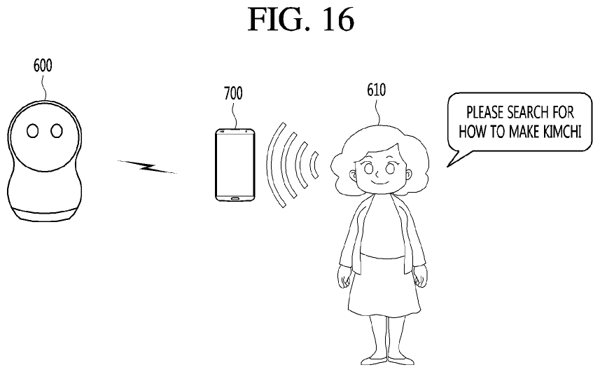

FIG. 16 is a view illustrating a method of acquiring a command word through an external device and performing a function corresponding thereto, according to another embodiment of the present disclosure.

The artificial intelligence unit 130 may acquire a command word by receiving a voice signal including the command word from the first device 700 of the plurality of devices.

Specifically, the first user 610 may utter the command word toward the first device 700 which is the personal device thereof.

In this case, the mic of the first device 700 may receive the voice signal including the command word and the controller of the first device 700 may transmit the voice signal including the command word to the artificial intelligence device 600.

In this case, the artificial intelligence unit 130 of the artificial intelligence device 600 may receive the voice signal including the command word through the communication unit 110 of the artificial intelligence device 600 and acquire the command word uttered by the first user 610 from the received voice signal.

In this case, the artificial intelligence unit 130 may determine the device for performing the function corresponding to the command word among the plurality of devices based on at least one of the user who has uttered the command word or the type of the function corresponding to the command word.

The artificial intelligence device acquires the command word of the user mainly using the method of receiving the voice signal.

When the distance between the artificial intelligence device and the user is large or when the artificial intelligence device and the user are located at different spaces, it may be difficult to input the command word. For example, the artificial intelligence device may be located in a living room and the user may be located in a room.

In this case, the user may simply input the command word using their personal device without approaching the artificial intelligence device and receive a desired function through a suitable device or their personal device.

Meanwhile, the controller generally controls the device and may be used interchangeably with a central processing unit, a microprocessor, a processor, etc.

The aforementioned present disclosure can also be embodied as computer readable code stored on a computer readable recording medium. The computer readable recording medium is any data storage device that can store data which can thereafter be read by a computer system. Examples of the computer readable recording medium include hard disk drive (HDDs), solid state drives (SSDs), silicon disk drives (SDDs), read-only memories (ROMs), random-access memories (RAMs), CD-ROMs, magnetic tapes, floppy disks, optical data storage devices, etc. The computer may also include the processor 180 of a terminal. It will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

1. An artificial intelligence device comprising:
a communication interface configured to communicate with a plurality of devices;
a microphone configured to receive voice;
an artificial intelligence interface configured to acquire a command word and determine a device for performing a function corresponding to the command word among the plurality of devices based on at least one of a user who has uttered the command word or a type of the function corresponding to the command word; and
a controller configured to transmit a command for performing the function corresponding to the command word to the determined device.

2. The artificial intelligence device of claim 1, further comprising a memory configured to store at least one of a plurality of pieces of device information respectively corresponding to a plurality of users, voice information of the plurality of users, preferred information of each of the plurality of users or types of functions corresponding to the plurality of devices.

3. The artificial intelligence device of claim 2,
wherein the artificial intelligence interface determines a device of the user who has uttered the command word as a device for outputting the function corresponding to the command word, based on the plurality of pieces of device information respectively corresponding to the plurality of users.

4. The artificial intelligence device of claim 2, wherein the artificial intelligence interface determines the device for performing the function corresponding to the command word, based on the type of the function corresponding to the command word and the types of the functions corresponding to the plurality of devices.

5. The artificial intelligence device of claim 4, wherein the artificial intelligence interface determines a preferred device of the user who has uttered the command word among the plurality of devices for performing the function corresponding to the command word as the device for performing the function corresponding to the command word.

6. The artificial intelligence device of claim 2, wherein the artificial intelligence interface performs a function corresponding to preferred information of the user who has uttered the command word, based on the preferred information of the user who has uttered the command word.

7. The artificial intelligence device of claim 1, wherein the artificial intelligence interface determines the device for performing the function corresponding to the command word, such that the function corresponding to the command word is performed in at least two of the plurality of devices and the artificial intelligence device.

8. The artificial intelligence device of claim 1, wherein the artificial intelligence interface acquires the command word, by receiving a voice signal including a command word from a first device of the plurality of devices.
